(19) United States
(12) Patent Application Publication
(10) Pub. No.: US 2025/0229754 A1
(43) Pub. Date: Jul. 17, 2025

(54) METHOD FOR ADJUSTING THE APPLIED PRESSURE OF A VEHICLE BRAKE AND VEHICLE BRAKE IN QUESTION

(71) Applicant: ZF CV Systems Global GmbH, Bern (CH)

(72) Inventors: Felix Müller-Deile, Hannover (DE); Rupert Kramer, Friedrichshafen (DE); Franz Bitzer, Friedrichshafen (DE); Uwe Bensch, Hannover (DE)

(21) Appl. No.: 19/171,018

(22) Filed: Apr. 4, 2025

Related U.S. Application Data
(63) Continuation of application No. PCT/EP2023/076462, filed on Sep. 26, 2023.

(30) Foreign Application Priority Data
Oct. 17, 2022 (DE) 10 2022 127 064.5

(51) Int. Cl. B60T 8/172; B60T 8/171

(52) U.S. Cl. CPC B60T 8/172; B60T 8/171; B60T 2240/00; B60T 2250/00

(57) ABSTRACT

A method is for adjusting an application pressure of a vehicle brake, in particular a commercial vehicle disc brake, of a motor vehicle while the motor vehicle is in motion. The method includes the following steps: applying an initial application pressure to the vehicle brake, determining a braking effect of the vehicle brake while the initial application pressure is applied to the vehicle brake, comparing the determined braking effect with a limit braking effect, reducing the initial application pressure to a reduced application pressure if the determined braking effect exceeds the limit braking effect.

### CROSS-REFERENCE TO RELATED APPLICATIONS

This application is a continuation application of international patent application PCT/EP2023/076462, filed Sep. 26, 2023, designating the United States and claiming priority from German application 10 2022 127 064.5, filed Oct. 17, 2022, and the entire content of both applications is incorporated herein by reference.

### TECHNICAL FIELD

The disclosure relates to a method for adjusting an application pressure of a vehicle brake, in particular a commercial vehicle disc brake, of a motor vehicle while the motor vehicle is in motion.

### BACKGROUND

Methods for adjusting the application pressure of a vehicle brake are known from the prior art and are based, for example, on parameterizing the application pressure and storing it in a brake control unit. When the brake pedal is pressed, a fixed parameterized application pressure is applied to overcome the air gap of the friction brake. Due to the application pressure the vehicle is ready to brake and the response times for a deceleration request can be implemented faster and smoothly.

The application pressure is the brake pressure that is applied to the brake system when the brake is to be kept ready for operation but there is no desire to decelerate. It is typically chosen in such a way that it is just large enough to overcome the mechanical friction of the brake caliper and reduce the distance between the brake disc and the brake pad, the so-called air gap, to almost zero, but at the same time the brake causes minimal friction losses. The application pressure is therefore subject to the conflict between the provision of the shortest possible braking reaction times on the one hand and the generation of the lowest possible frictional torques on the other.

Although methods known from the prior art have proven themselves to ensure an advantageous response of the vehicle brake by applying the application pressure, it has been observed that the application of the application pressure can lead to considerable frictional torques and thus braking forces in reality even if no deceleration is required and desired. This increases the wear of the vehicle brake. There is particular potential for optimization in electrically powered commercial vehicles with an electric drive and an electronically controlled pneumatic braking system (EBS). This is because in the event that the vehicle brake is mounted on an electrically powered vehicle, kinetic energy is also lost, which is then no longer available for recuperation.

### SUMMARY

It is an object of the disclosure to develop a method such that the disadvantages found in the prior art are eliminated as far as possible. In particular, a method was to be specified which optimizes the setting of the application pressure for a vehicle brake in order to reduce undesirable frictional torques on the brake.

According to the disclosure, the object is achieved with a method of the kind mentioned at the outset by the following steps: applying an initial application pressure to the vehicle brake, determining a braking effect of the vehicle brake while the initial application pressure is applied to the vehicle brake, comparing the determined braking effect with a limit braking effect, reducing the initial application pressure to a reduced application pressure if the determined braking effect exceeds the limit braking effect.

The disclosure makes use of the finding that by determining a braking effect of the vehicle brake while the initial application pressure is applied to the vehicle brake, it can be checked whether the selected initial application pressure generates frictional torques and thus braking forces that exceed a definable level, here referred to as the limit braking effect, if no braking effect is required and desired operationally. If this is the case and the limit braking effect is exceeded, it is proposed to reduce the application pressure. This avoids unnecessarily high braking torques when the brake is not in use. In addition, the wear of the wheel brakes or brake pads decreases. At the same time, more kinetic energy is available for recuperation, so that the range of an electrically powered vehicle can be increased or the battery can be smaller. In the context of the disclosure, a braking effect is understood to mean both a braking force and a braking torque, which are generated when the application pressure is applied to the brake.

The limit braking effect is preferably determined empirically and stored in a control system. It represents the braking effect wherein exceeding this braking effect causes the application pressure to be reduced. Overall, a slight reduction of the initial application pressure ensures that the vehicle brake continues to respond favorably, that is, that a desired deceleration is generated quickly. To this end, the method ensures that the air gap continues to be minimally adjusted. The limit braking effect can be defined as desired and, depending on the desired application area, can also be zero, for example, that is, it can be selected in such a way that after optimization, there should no longer be any measurable braking effect after the application pressure has been applied. Preferably, the limit braking effect is so low that it can still be measured using existing measuring equipment.

The subject-matter of the disclosure is developed by defining the reduced application pressure as the new initial application pressure and the method further includes: repeating the steps of the method until the determined braking effect is less than the limit braking effect. In this respect, it is proposed to reduce the application pressure iteratively in such a way that the determined braking effect does not exceed the limit braking effect. In this way, the point in the optimization process can be reached particularly sensitively where, for example, no braking effect is generated if this is not desired when the desired braking force is zero or almost zero, and at the same time the air gap is so small that the response time of the brake is minimized.

According to an embodiment, the braking effect of the vehicle brake is determined via at least one wheel sensor. The wheel sensor determines a deceleration of the wheel, which in turn is a measure of the braking effect of the brake. In this respect, sensors are used for this embodiment, which in many cases already exist on commercial vehicles anyway. Extensive hardware retrofits are therefore not necessary. The implementation of the method according to the disclosure can be achieved cost-effectively.

According to an alternative embodiment, the braking effect of the vehicle brake is determined on the basis of a torque change of an electric vehicle drive of the motor vehicle. In this case, the information already available in an electrically powered vehicle about the current torque of the drive can be used to determine whether the application pressure has an undesirable braking effect. Specifically, for a scenario where the electrically powered vehicle is operating at a constant speed with cruise control activated, in order to keep the speed of the vehicle constant the electric vehicle drive would increase the torque thereof to compensate for the braking effect of the brake when the application pressure is applied. This increase in drive torque can now be used as a measure of whether the application pressure is optimally set or whether it is so high that an undesirable braking effect is generated when the application pressure is applied.

According to an embodiment, the limit braking effect is defined in such a way that no measurable braking effect occurs at the vehicle brake. In other words, the optimization method is completed when the application pressure has been optimized in such a way that no measurable braking effect, for example in the form of a braking force or a braking torque, occurs or can be measured on the vehicle brake or on the entire vehicle when it is applied. This manifests itself in the fact that after the application of the application pressure there is no measurable vehicle deceleration or measurable increase in the drive torque of the drive motor of the vehicle if it is configured so as to keep the vehicle speed constant. As described, this is advantageous for avoiding unnecessarily high braking torques, for reducing wear on the wheel brakes and for providing kinetic energy for recuperation.

Preferably, the initial application pressure can be selected before the first run of the method in such a way that the application of the initial application pressure completely or almost completely overcomes the air gap of the vehicle brake. This ensures that a deceleration request can be quickly realized via the brake. The initial application pressure is preferably a fixed stored parameterized application pressure.

Preferably, the initial application pressure can be applied for a period of one second to 10 seconds. In this way, the braking effect of the brake or vehicle can be determined safely and reliably despite the inertia present in the overall system. At the same time, the ambient conditions remain largely constant during the braking process. For the embodiment for which the application of the application pressure causes a deceleration of the vehicle, the time span is preferably in the range of one second to 5 seconds. This avoids disturbing the ride comfort and causing the driver to compensate for the deceleration. For the embodiment for which the electric vehicle drive compensates for the braking effect or braking force by increasing torque, the time span is preferably in the range of 3 seconds to 10 seconds from control engineering considerations.

According to an embodiment, the reduction of the initial application pressure is carried out in such a way that the initial application pressure is reduced by a defined pressure difference. Preferably, the pressure difference is 0.05 bar to 0.1 bar. The procedure in question and the corresponding pressure difference have proven to be particularly preferred for a variety of applications.

In accordance with an embodiment, the method is carried out for several or all vehicle brakes of the motor vehicle, in particular for all vehicle brakes of one or more axles of the motor vehicle or for all vehicle brakes of the motor vehicle. In this respect, the overall efficiency of the entire vehicle system can be positively influenced. In the event that the vehicle is an electrically powered vehicle, more energy is thus available for recuperation and, as a result, the total vehicle range increases or the battery power required for a desired range decreases.

According to an embodiment, the initial application pressure is applied to the vehicle brake periodically. The periodic application of the initial application pressure ensures that the application pressure is regularly checked and adapted to any changes in parameters. For example, increasing brake wear makes it necessary to adjust the application pressure. However, this can also result from changed environmental conditions. Preferably, a shorter interval duration is provided for the initial performance of the method. For example, the interval duration after the vehicle has been put into operation, combined with a reset of the ignition, can be in the range of 30 seconds to 2 minutes. After an optimal application pressure has been determined, the interval duration is preferably increased, for example to 15 minutes to 30 minutes.

According to another embodiment, the method has the step: Increasing the initial application pressure if the determined braking effect is less than a minimum braking effect. In this way, it can be ensured that the application pressure is not reduced to such an extent that the air gap takes on too large values and thus the reaction time of the brake increases undesirably.

The disclosure has been described above with reference to a method. In another aspect, the disclosure relates to a control unit for a vehicle brake of a commercial vehicle. The disclosure achieves the object described at the outset with regard to the control unit by setting it up to execute the method according to one of the above embodiments. In accordance with an embodiment, the control unit is in the form of a dedicated control unit or of a central control unit. The control unit makes use of the same advantages and embodiments as the method according to the disclosure and vice versa. In this regard, reference is made to the above embodiments and the content thereof is included here.

In another aspect, the disclosure relates to a computer program product. The disclosure achieves the object described at the outset with respect to the computer program product in that this contains commands which, when executed on a computer, cause the computer to form a control unit according to one of the above embodiments and/or to execute the method according to one of the above embodiments. The computer program product also makes use of the same advantages and embodiments as the method according to the disclosure and the control unit according to the disclosure and vice versa. In this regard, reference is made to the above embodiments and the content thereof is included here.

In another aspect, the disclosure relates to a motor vehicle, in particular a commercial vehicle. The disclosure achieves the object described at the outset with regard to the motor vehicle in that it contains at least one vehicle brake and one control unit, which are configured according to one of the above embodiments. Preferably, the motor vehicle is in the form of an electrically powered motor vehicle. The motor vehicle also makes use of the same advantages and embodiments as the method according to the disclosure, the control unit according to the disclosure and the computer program product according to the disclosure and vice versa. In this regard, reference is made to the above embodiments and the content thereof is included here.

### BRIEF DESCRIPTION OF DRAWINGS

The invention will now be described with reference to the drawings wherein:

FIG. 1 shows an embodiment of a motor vehicle according to the disclosure with a vehicle brake according to the disclosure in a schematic view;

FIG. 2 shows a first embodiment of a method for adjusting an application pressure of a vehicle brake as a block diagram;

FIG. 3 shows a second embodiment of a method for adjusting an application pressure of a vehicle brake as a block diagram;

FIG. 4 shows a schematic representation of a control unit according to the disclosure;

FIG. 5 shows a schematic representation of a computer program product according to the disclosure; and,

FIG. 6 shows a schematic representation of a motor vehicle according to the disclosure with a control unit according to the disclosure.

### DETAILED DESCRIPTION

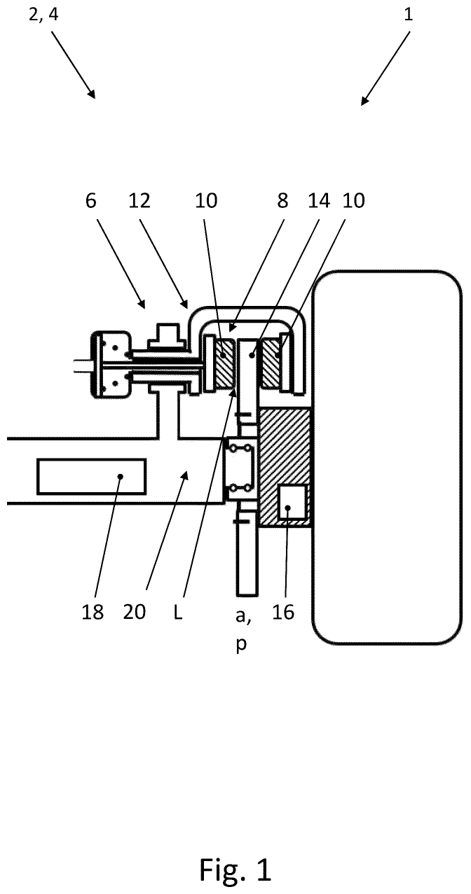

FIG. 1 shows a motor vehicle 1, which is only schematically shown here. The motor vehicle 1 has a vehicle brake 2. In the present case, the vehicle brake 2 is in the form of a commercial vehicle disc brake 4. The vehicle brake 2 has a brake carrier 6. The brake carrier 6 has a brake pad mount 8. Two brake pads 10 which are arranged in the brake pad mount 8 can be moved axially and are supported in the brake pad mount 8. The vehicle brake 2 also has a brake caliper 12 that can be moved axially relative to the brake carrier 6. In the condition shown in FIG. 1, the vehicle brake 2 has an air gap L, which describes the distance between a brake disc 14 and the brake pad 10.

Furthermore, a wheel sensor 16 is assigned to the vehicle brake 2 and is set up to determine a braking effect Fb of the brake disc 14, especially when an application pressure p is applied to the vehicle brake 2. The motor vehicle 1 also has an electric vehicle drive 18, which, as shown here by way of example, is arranged on an axle 20.

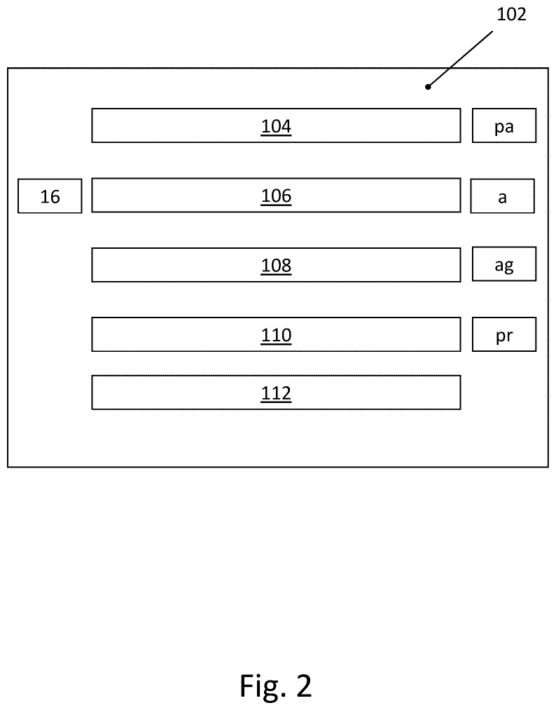

FIG. 2 shows a block diagram of a first embodiment of a method 102 according to the disclosure for setting an application pressure p of a vehicle brake 2 of a motor vehicle 1. The vehicle brake 2 is in particular a commercial vehicle disc brake 4. The method has a step 104, according to which an initial application pressure pa is applied to the vehicle brake 2. Subsequently, in step 106, a braking effect Fb of the vehicle brake 2 is determined while the initial application pressure pa is applied to the vehicle brake 2. The method also includes step 108, according to which the determined braking effect Fb is compared with a limit braking effect Fg. If the determined braking effect Fb exceeds the limit braking effect Fg, the initial application pressure pa is reduced to a reduced application pressure pr in step 110.

Preferably, the reduced application pressure pr is defined as the new initial application pressure pa, wherein the method includes the step: Repeating 112 the method steps 104 to 110 until the determined braking effect Fb is less than the limit braking effect Fg.

In the embodiment shown in FIG. 2, the determination 106 of the braking effect Fb of the vehicle brake 2 is carried out via at least one wheel sensor 16. The deceleration of the motor vehicle 1 is thus a measure of the braking effect Fb of the vehicle brake 2. The limit braking effect Fg is defined in such a way that no measurable braking effect occurs at the vehicle brake 2. Furthermore, the initial application pressure pa is selected before the first run of the method 102 in such a way that the air gap L of the vehicle brake 2 is completely or almost completely overcome by applying the initial application pressure pa.

The application 104 of the initial application pressure pa is carried out in particular for a period of one second to 10 seconds. Furthermore, the reduction 110 of the initial application pressure pa is carried out in such a way that the initial application pressure pa is reduced by a defined pressure difference. The method 102 may be carried out for one, several or all vehicle brakes 2 of the motor vehicle 1, in particular for all vehicle brakes 2 of one or more axles 20 of the motor vehicle 1 or for all vehicle brakes 2 of the motor vehicle 1. In FIG. 1, only one of the vehicle brakes 2 of the motor vehicle 1 is schematically shown. Furthermore, the application of the initial application pressure pa is preferably carried out periodically.

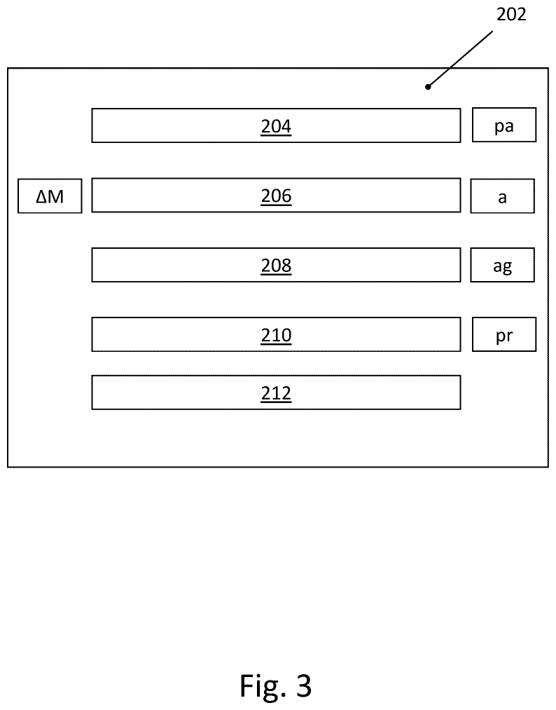

FIG. 3 shows a block diagram of an alternative embodiment of a method 202 according to the disclosure for setting an application pressure p of a vehicle brake 2 of a motor vehicle 1, wherein the vehicle brake 2 is in particular in the form of a commercial vehicle disc brake 4. The method has the following steps: applying 204 an initial application pressure pa to the vehicle brake 2, determining 206 a braking effect Fb of the vehicle brake 2 while the initial application pressure pa is applied to the vehicle brake 2, comparing 208 the determined braking effect Fb with a limit braking effect Fg, reducing 210 the initial application pressure pa to a reduced application pressure pr if the determined braking effect Fb exceeds the limit braking effect Fg.

Preferably, after the run of the method 202, the reduced application pressure pr is defined as the new initial application pressure pa. In this respect, the method 202 also includes the step: Repeating 212 steps 204 to 210 of the method until the determined braking effect Fb is less than the limit braking effect Fg. In contrast to the method 102 according to the first embodiment, the method 202 determines 206 the braking effect Fb of the vehicle brake 2 on the basis of a torque change ΔM of an electric vehicle drive 18 of the motor vehicle 1, while this keeps the vehicle speed constant. The other features of the method and embodiments correspond to those from the embodiment according to FIG. 2, so that reference is made to them in order to avoid repetition.

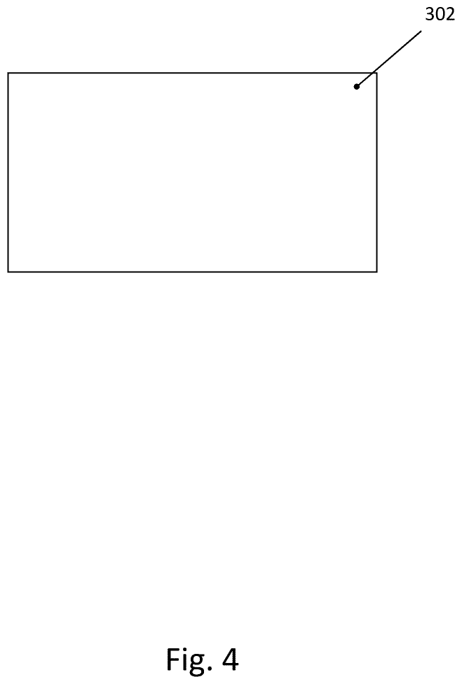

FIG. 4 schematically shows a control unit 302 for a vehicle brake 2 of a motor vehicle 1. The control unit 302 is set up to carry out the method 102, 202 according to FIG. 2 or 3. The control unit 302 can be in the form of a dedicated control unit 302 or of a central control unit 302.

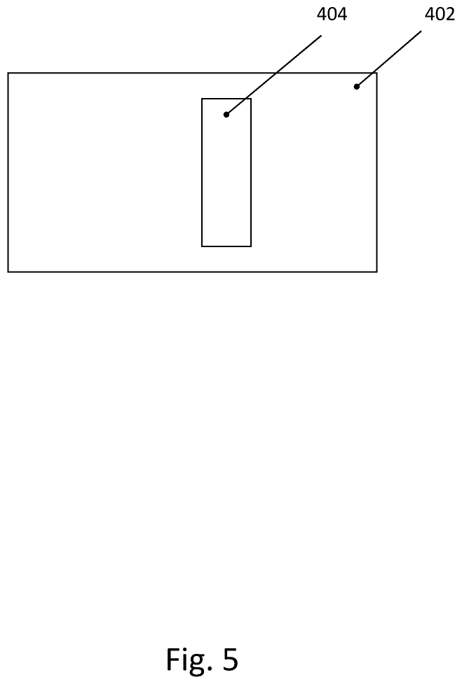

FIG. 5 schematically shows a computer program product 402. The computer program product 402 contains commands which, when executed on a computer, cause the computer to form a control unit 302 as specified in FIG. 4 and/or to perform the methods 102, 202 of FIGS. 2 and 3.

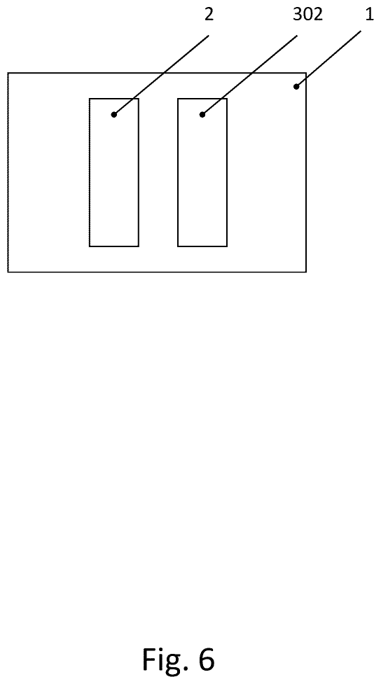

FIG. 6 schematically shows a motor vehicle 1 with a vehicle brake 2 and a control unit 302. The control unit 302 corresponds to the control unit 302 according to FIG. 4. The motor vehicle 1 is in particular in the form of an electrically powered motor vehicle 1.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Motor vehicle
2 Vehicle brake
4 Commercial vehicle disc brake
6 Brake carrier
8 Brake pad mount
10 Brake lining
12 Caliper
14 Brake disk
16 Wheel sensor
18 Electric vehicle drive
20 Axle
102 Adjustment method
104 Applying an initial application pressure
106 Determining a braking effect of the vehicle brake
108 Comparing the determined braking effect with a specified limit braking effect
110 Reducing the initial application pressure
112 Repeat the steps of the method
202 Adjustment method
204 Applying an initial application pressure
206 Determining a braking effect of the vehicle brake
208 Comparing the determined braking effect with a specified limit braking effect
210 Reducing the initial application pressure
212 Repeat the steps of the method
302 Control unit
402 Computer program product
404 Commands
Fb Braking effect
Fg Limit braking effect
L Air gap
ΔM Torque change
p Application pressure
pr Reduced application pressure
pa Initial application pressure

1. A method for adjusting an application pressure of a vehicle brake of a motor vehicle while the motor vehicle is in motion, the method comprising:
applying an initial application pressure to the vehicle brake;
determining a braking effect of the vehicle brake while the initial application pressure is applied to the vehicle brake;
comparing the determined braking effect with a limit braking effect; and,
reducing the initial application pressure to a reduced application pressure if the determined braking effect exceeds the limit braking effect.

2. The method of claim 1, wherein the reduced application pressure is defined as a new initial application pressure, the method further comprising:
repeating said applying the initial application pressure, said determining the braking effect, said comparing the determined braking effect with the limited braking effect, and said reducing the initial application pressure until the determined braking effect is less than the limit braking effect.

3. The method of claim 1, wherein said determining the braking effect of the vehicle brake is carried out via at least one wheel sensor.

4. The method of claim 1, wherein said determining the braking effect of the vehicle brake is carried out on a basis of a torque change of an electric vehicle drive of the motor vehicle.

5. The method of claim 1, wherein the limit braking effect is defined such that no measurable braking effect occurs at the vehicle brake.

6. The method of claim 1, wherein the initial application pressure is selected before a first run of the method such that an air gap of the vehicle brake is completely or almost completely overcome by applying the initial application pressure.

7. The method of claim 1, wherein said applying the initial application pressure is carried out for a period of one second to 10 seconds.

8. The method of claim 1, wherein said reducing the initial application pressure is carried out such that the initial application pressure is reduced by a defined pressure difference.

9. The method of claim 8, wherein the defined pressure difference is 0.05 bar to 0.1 bar.

10. The method of claim 1, wherein the method is carried out for several or all vehicle brakes of the motor vehicle.

11. The method of claim 1, wherein the method is carried out for all vehicle brakes of one or more axles of the motor vehicle.

12. The method of claim 1, wherein said applying the initial application pressure to the vehicle brake is carried out periodically.

13. The method of claim 1, wherein the vehicle brake is a commercial vehicle disc brake.

14. A control unit for a vehicle brake of a commercial vehicle, the control unit comprising:
a processor;
a non-transitory computer readable medium having program code stored thereon for adjusting an application pressure of a vehicle brake of a motor vehicle while the motor vehicle is in motion;
said program code being configured, when executed by said processor, to:
apply an initial application pressure to the vehicle brake;
determine a braking effect of the vehicle brake while the initial application pressure is applied to the vehicle brake;
compare the determined braking effect with a limit braking effect; and,
reduce the initial application pressure to a reduced application pressure if the determined braking effect exceeds the limit braking effect.

15. The control unit of claim 14, wherein the control unit is a dedicated control unit or a central control unit.

16. A computer program product comprising commands stored on a non-transitory computer readable medium, which, when they are executed on a computer, cause the computer to form the control unit of claim 14.

17. A computer program product comprising commands stored on a non-transitory computer readable medium, which, when they are executed on a computer, cause the computer to carry out the method of claim 1.

18. A motor vehicle comprising:
a vehicle brake;
a control unit having a processor and a non-transitory computer readable medium;
said non-transitory computer readable medium having program code stored thereon for adjusting an application pressure of a vehicle brake of a motor vehicle while the motor vehicle is in motion;
said program code being configured, when executed by said processor, to:
apply an initial application pressure to the vehicle brake;
determine a braking effect of the vehicle brake while the initial application pressure is applied to the vehicle brake;
compare the determined braking effect with a limit braking effect; and,
reduce the initial application pressure to a reduced application pressure if the determined braking effect exceeds the limit braking effect.

19. The motor vehicle of claim 18, wherein the motor vehicle is an electrically powered motor vehicle.

20. The motor vehicle of claim 18, wherein the motor vehicle is a commercial vehicle.
